(19) United States
(12) Patent Application Publication
(10) Pub. No.: US 2010/0219662 A1
(43) Pub. Date: Sep. 2, 2010

(54) PROCESS AND DEVICE FOR PRODUCING A MOLDING WITH A PREDETERMINED RUPTURE LINE FOR AN AIRBAG OPENING

(75) Inventor: Hans Schirmer, Heiteren (FR)

Correspondence Address: URSULA B. DAY, ESQ., 708 Third Avenue, SUITE 1501, NEW YORK, NY, 10017, US

(73) Assignee: Peguform GmbH, Boetzingen (DE)

(21) Appl. No.: 12/738,476

(22) PCT Filed: Aug. 25, 2008
(86) PCT No.: PCT/EP08/06953

§ 371 Date: Apr. 16, 2010

(30) Foreign Application Priority Data
Oct. 23, 2007 (EP) 07020696.6

(51) Int. Cl. B62D 29/04; B29C 45/14; B29C 45/26

(52) U.S. Cl. 296/191; 264/250; 264/46.4; 425/553

(57) ABSTRACT

The present invention provides a process for producing a molding having a predetermined rupture line (12) for an airbag opening, said process comprising at least two injection molding cycles, wherein initially in a mold (1) with a first mating mold component (3) a support layer (8) is formed and, in a second step, in the same mold (1) with a second mating mold component (13), a decorative layer or foam layer (10) is applied to the support layer (8), into which decorative or foam layer a predetermined rupture line (12) for an airbag opening is introduced during the shaping process by means of a perforation tool (4) integrated into the mold.

The present invention refers to a process for the production of a molded part which includes a predetermined rupture line for an airbag opening with the features as in the preamble of claim 1.

The invention refers in addition to a device for the production of a molded part having a predetermined rupture line for an airbag opening with features of the preamble in claim 14, as well as the use of the molded part for interior paneling for motor vehicles, in particular, dashboards, side paneling and door paneling.

Molded parts from plastic are utilized in many areas in the motor vehicle industry, in particular, as parts for the interior paneling, such as for example, dashboards, column paneling, door paneling, side paneling etc. Normally, such molded parts that are utilized for interior paneling consist of several layers of plastic, with each layer having specific properties. Thus, dashboards for example, consist of a hard support layer, which is constructed from a glass fiber reinforced thermoplastic material with a layer of foam, for example, of polyurethane deposited thereon. The foam layer is frequently provided with a decorating layer which forms the visual side of the molded part. In this manner, the support with a back foamed film provided with a decorating structure that is visually pleasing, is for example, connected in a laminating tool.

It is however also possible, when providing a suitable selection of the type of plastic and a corresponding surface in the mold tool, to form the decorative surface directly at the support by spray-coating it with a thermoplastic material.

Thus, in DE 10 2005 039 124 A1, a method for producing a dual layered composite part, where the support is formed from a fiber reinforced thermoplastic material in a first cavity by means of an injection molding process and thereafter is injection molded with a thermoplastic material without any fibers in an injection molding process in a second cavity. In this case, the second cavity exhibits a grain at its surface, which produces a grain at the surface of the outer layer.

As already afore-stated, such composite parts are utilized as interior paneling for motor vehicles, such as for example, dash boards, column paneling, door paneling and side paneling. Today, the interior paneling regularly serves simultaneously as covers for the airbag module. In order to facilitate opening the air bag and its deployment into the interior of the car, the support layers of the corresponding molded part for the interior paneling are frequently provided with predetermined rupture lines. When the airbag is activated, the expanding airbag strikes the support layer which then breaks along the predetermined rupture lines.

Predetermined rupture lines for air bag covers are normally introduced from the rear side in the support of the molded part after completion of the molded part by means of a laser or a milling unit. The drawback of applying this method is that an additional manufacturing step is required, which in addition, must undergo a precise production control so that the molded part does not get damaged.

In DE 199 58 865 A1, a manufactured air bag cover device for motor vehicles is described having a support layer which includes predetermined rupture lines in the cover area of the airbag. For the production of these predetermined rupture lines, it is proposed to provide a part of the mold tool with at least one blade tool that is transferable into the hollow of the molded part. Thus, the injection mold acts as a base mold part in which an elongated blade is movably disposed as a blade tool. Moreover, the injection mold includes a first and a second mold counter piece, which is located opposite the base mold part, whereby a cavity is formed by means of the first mold counter piece and designed for receiving the polymer material for a crack protector, while the second mold counter piece includes the cavity for the support.

During injection, the elastomeric material which forms the part of the crack protector part, the cutting edge of the blade of the blade tool extends close to the first mold counter piece and remains in this position until the injection of the elastomeric material is finished and the crack protector part is partially cooled.

Subsequently, a second cavity is formed through exchanging the first mold counter piece with the second mold counter piece, into which the polymer material is injected for producing the support layer. The injection of the polymer material for the support layer is carried out while the elastomeric material for the crack protector part is still hot, which is typically still at a temperature between 80° C. and 200° C. Simultaneously, through advancing the blade closely up to the surface of the second mold counterpart, the support layer is being weakened up to a small residual thickness of the material. This advancement of the blade happens typically at a temperature of the support layer of about 100° C. to 240° C. and the blade remains in that position until the carrier material has cooled to about 80° C.

Precondition for carrying out the afore-described method is that the first layer for the crack protector part is an elastomeric layer which is able to absorb the material stresses while the predetermined rupture line is put in place and which can resiliently escape pressure from the cutting tool. The afore-stated method is not suitable for putting predetermined rupture lines into a molded part which consists of a rigid support layer and a sprayed-on decorating or foam layer, since pushing the blade through from the solidified support layer would lead to the destruction of the decorating layer or the foam layer.

Thus, there exists a continued object to find a method which does not suffer from the drawbacks of the afore-described prior art.

This object is solved by the method with the features of claim 1.

It is also an object of the present invention, to provide a device for the production of a predetermined rupture line for an airbag opening in a molded part with which to produce such molded part under avoidance of the drawbacks of the prior art.

A solution to this object is provided by the device which includes the features of claim 14.

Advantageous embodiments of the method as well as the device are reflected in the dependent claims.

While the conventional production of molded parts for interior paneling of motor vehicles normally extends over three steps, and may be also manufactured in three different mold tools, according to the present invention, a molded part is produced in a two step process with a single mold tool, whereby a predetermined rupture line for an air bag cover is introduced into the molded part during the process.

In a conventional method for the production of a dash board, for example, an elastic decorating film is first produced as a slush skin in a slush casting process. In a second step, this film is being back injection molded and the resulting molded part is joined with a support, in a third step.

In the present invention, on the other hand, a support layer is formed in a two-step mold tool in a first phase with a first mold counter piece with a first cavity in a first injection molding cycle. Subsequently, the mold tool is opened and the base mold together with the support is combined with a second mating mold component, whereby a second cavity is formed into which the polymer material for the decorating layer is injected in a second injection molding cycle. In a preferred embodiment of the present invention, the polymer used is a thermoplastic elastomeric material to which a foaming agent was added and which is injection molded for depositing a foamed layer, whereby by means of a controlled expansion lift of the injection mold tool during the second injection molding cycle, a foamed layer with a decorating surface is formed.

During the first injection molding cycle, openings are formed in the support layer, through which a perforation tool, integrated into the base mold of the mold tool, is introduced during the second injection molding cycle into the decorating or foam layer.

Thermoplastic materials that can be utilized for the support are polypropylene (PP), polyethylene (PE), polybutyleneterephthalate (PBT), polyamid (PA), polystyrene (PS), polycarbonate (PC), polymethylmetacrylate (PMMA), acryInitril-butadiene-styrene (ABS) acryInitril-butadiene-styrene/polycarbonate copolymerisate (ABS-PC) or polyoxymethylene (POM), whereby in a preferred embodiment, the polymer material is reinforced with fibers. Fibers can be glass fibers, carbon fibers or also textile natural fibers, such as hemp and sisal.

The decorating layer is formed from a thermoplastic elastomeric material (TPF) on the basis of polyurethane (PU), polypropylene (PP), polyethylene (PE) or (polyamid) (PA). In a preferred embodiment of the present invention, thermoplastic elastomeric material loaded with a foaming agent is utilized.

The mold tool is a single, at least two-step mold tool which comprises a base mold and at least two mating mold components, wherein integrated into the base mold is a perforation tool which is provided with a cutting blade or perforation needles.

The mold tool is designed such that in the first step a support layer in which openings are formed is created by means of the base mold and a first mold counter piece in a first cavity, and during a second injection cycle with a second mold counter piece, the perforation tool or the perforation elements such as, for example, a cutting blade or a needle, are introduced through the openings into the decorating layer or the foamed layer.

If a foamed decorating layer is to be produced, then for this second step, a thermoplastic elastomeric material which is loaded with a foaming agent is utilized and during the second injection cycle, the mold tool passes at the same time an expansion lift, wherein the foaming agent that is dissolved in the polymer material expands forming a foaming layer whose core exhibits a low density, while the outer skin and the neighboring layer is formed in a compact and even manner. The quality of the outer skin is of such high quality that the outer skin can be easily utilized as the viewing side and as a decorating surface.

An essential step in the invention with the afore-described process is the formation of openings in the support layer during the first injection molding cycle with the aid of a perforation tool which is integrated into the base mold of the mold tool. These openings can be formed either by means of the integrated perforation tool directly or else, with the aid of knobs which are integrated into the mold tool and provided with perforation tools.

It is contemplated that the perforation tool integrated into the mold tool is introduced during or after the expansion lift in the second injection molding cycle into the not yet solidified thermoplastic elastomeric material of the decorating- or foam layer, such that in the extended position of the perforation tool at the end of the second injection molding cycle, a thin and non-weakened wall remains in the decorating- or foam layer.

In an advantageous embodiment of the invention, a foamed decorating layer is to be deposited onto the support, the mold cavity of the mold tool is first run to a minimal volume for the second injection molding cycle and is then completely filled with injection molding mass that is loaded with the foaming agent. This allows the injection pressure to be held so high that the injection molding mass is not yet foaming up. In this manner, starting from the walls of the mold cavity, an essentially foam free cover layer is first formed and the expansion lift is being initiated at that moment in which the desired thickness of the cover layer is reached. Through timely and graded control of the tool lift, the wall thickness of the cover layer as well as the thickness of the core of the foam structure can be produced in variable manner and independently from each other. After solidification of the foam structure, the tool is opened completely and the finished molded part removed. The foam free cover layer is suitable for a decorating layer and can then be provided by means of suitable structures at the tool surface with a grain or other decorative textures.

The perforating tool itself remains in the solidifying foam or in the solidifying elastomeric material until the layer is cooled to about 80° C. and can then again be retracted whereby the finished predetermined rupture line or perforation remains in the decorating layer or the foam layer.

With the afore-described method, it was possible for the first time to produce in a single mold a complete molded part for the interior paneling of a motor vehicle in an injection molding process and at the same time form in the molded part a predetermined rupture line for an airbag cover.

The afore-described two-step method, where the compact support layer is formed in the first step, while in the second step, a decorating layer or a decorative foam layer is formed, is specifically suited for the production of molded parts for interior paneling of motor vehicles. The method can be easily extended to a three or more step process in case further layers are desired and multilayer molded parts are the object. In that case, a suitable number of mold counter pieces are required which are utilized successively. In that case, the predetermined rupture lines are likewise formed in the molded part through integration of the perforation tool into the base mold tool during the forming process.

In the following paragraphs, a preferred embodiment of the present invention, where a decorative foam layer is deposited onto a support, is described with reference to the drawings, which show in:

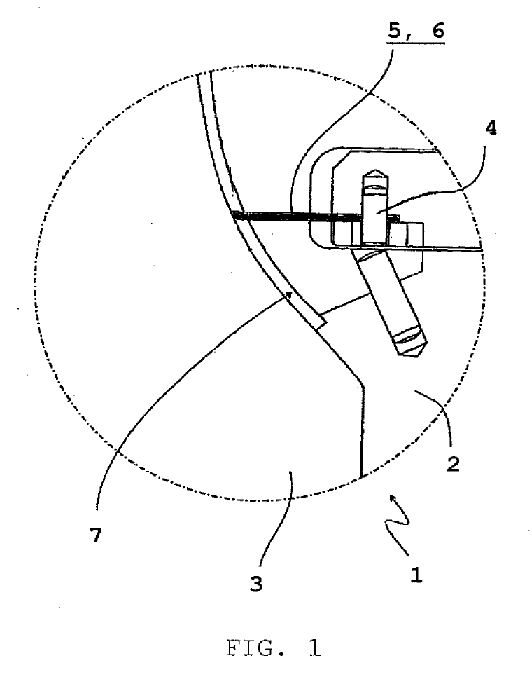

FIG. 1 a section through a partial area of a mold tool with a perforation tool integrated into the base mold tool, combined with a first mating mold component.

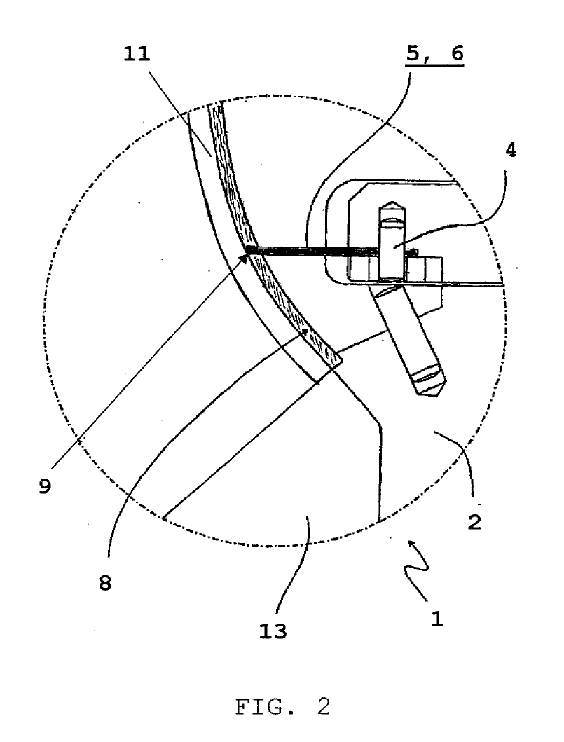

FIG. 2 a section through a partial area of a mold tool with a perforation tool integrated into the base mold tool, combined with a second mating mold component prior to the expansion lift.

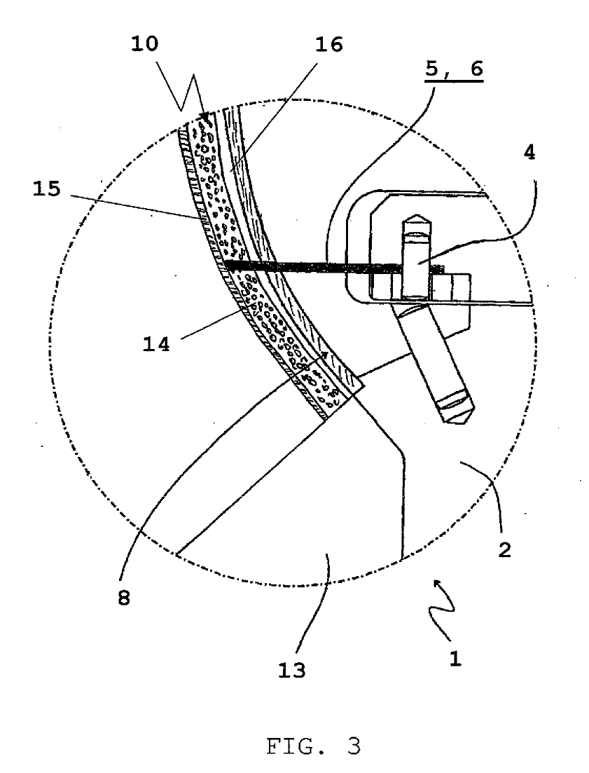

FIG. 3 a section through a partial area of a mold tool with a perforation tool integrated into the base mold tool, combined with a second mating mold component after the expansion lift.

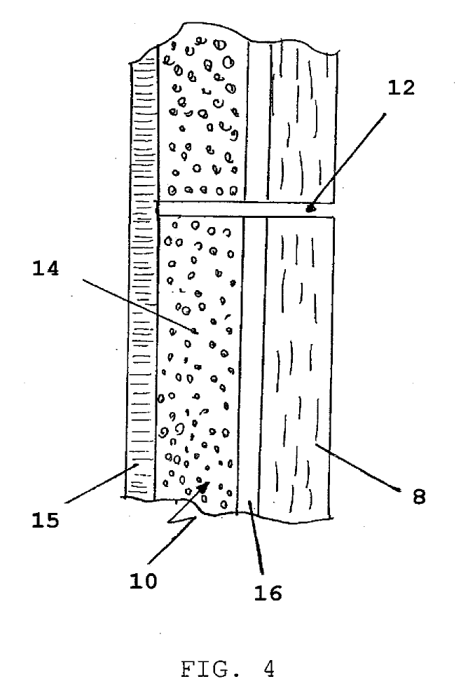

FIG. 4 a cross section through a molded part having predetermined rupture lines.

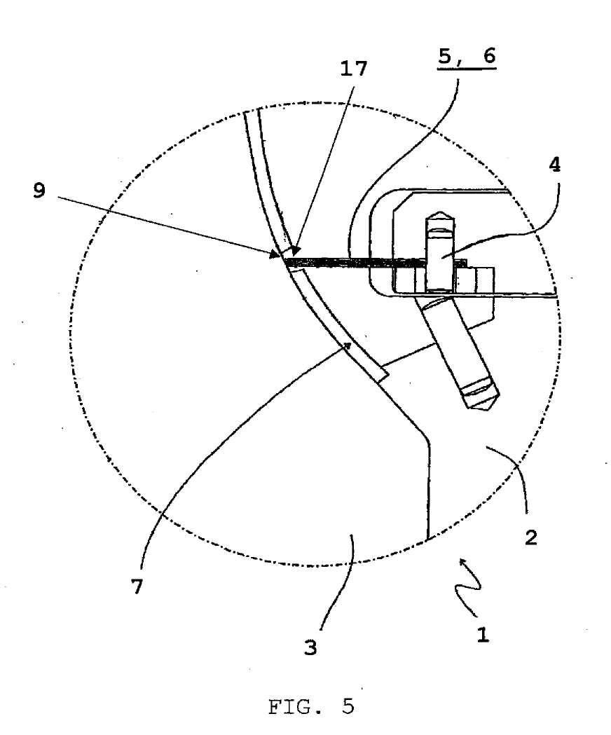

FIG. 5 a section through a partial area of a mold tool with a perforation tool integrated into the base mold tool, combined with a first mating mold component.

FIG. 1 shows a section through a detail of a mold tool 1 with a base mold 2 and a first mold counter piece 3, wherein a perforation tool 4 is integrated into the base mold 2. The perforation tool 4 is provided with a movable perforation blade 5 or a movable perforation needle 6 and projects into a first cavity 7 which is formed between the base mold 2 and the first mold counter piece 3. Thereby, the perforation tool 4, with the perforation needle 6 or the cutting blade 5, extends up to the surface of the first mold counter piece 3, such that at these locations openings are formed during the injection of the polymer material into the mold tool 1 for the support 8. FIG. 1 shows a snapshot before the start of the actual forming process, where the cavity 7 is not yet filled with polymer material.

FIG. 2 shows the same section of the same detail of mold tool 1 after the first injection molding cycle where the support layer 8 is now formed in the area of the first cavity 7. The perforation needle 6 or the cutting blade 5 of the perforation tool 4, projects into the support layer 8 and thus forms an opening 9 in the support layer 8. FIG. 2 provides a snapshot before the second injection molding cycle, where the base mold is already combined with the second mating mold component 13, the support layer 8 already solidified and between the two mold tool members or between the second mold counter piece 13 and the surface of the support 8, a second cavity 11 is formed.

FIG. 3 shows a section through the same detail of mold tool 1 as in FIGS. 1 and 2 after the second injection molding cycle. Thereby, the base mold 2 with the integrated perforation tool 4 remains combined with the second mold counter piece 13 in unaltered fashion. The thermoplastic elastomeric material fills the second cavity 11 and after the cycled expansion lift, a foam layer 10 has formed with a foam core 14 and two compact marginal layers 15, 16. The perforation needle 6 or the cutting blade 5 of the perforation tool 4 severs the foam layer and is moved up to the compact outer skin.

FIG. 4 shows a section through a partial area of the completed multilayered molded part, wherein the construction of the molded piece is easily seen. At the support 8, a foamed layer 10 is deposited, which consists of a foamed core 14 an intermediate layer 16 and a decorating skin 15. This detail of the molded part exhibits a predetermined rupture line 12 which extends through the support and the foam layer up to the decorating skin 15.

FIG. 5 shows an embodiment of the present invention with an additional realization for the integration of the perforation tool 4. Thereby, the base mold 2 of the mold tool 1 is provided in the area of the first cavity 7 with knobs 17, into which the perforation tool 4 is integrated with cutting blade 5 or perforation needle 6. Knobs 17 extends up to the surface of the first mating mold component 3 and thus forms an opening 9 in the later support 8 through which the perforation element 5, 6 of the perforation tool 4 can be brought into the foamed layer 10 in the second injection molding cycle. In this embodiment perforation needles 6 are preferred and the predetermined rupture line is formed by means of serially combining single knobs distanced from each other and provided with perforation needles in the base mold 2 of the mold tool 1.

The exclusive depiction in the drawings of producing a foamed decorating layer, the method of the present invention is not limited thereto, and the method is likewise suitable for the deposit of non-foamed decorating layers into a support, whereby a thermoplastic elastomeric without an expansion agent is utilized for the second injection molding cycle and thus an expandable mating mold component is also not required.

In the embodiment as shown here in the drawings, the perforation groove moreover ends before the compact outer layer. There is also no limitation of the present invention in this feature. Essential for the invention is that a thin unweakened wall remains, whereby the perforation needle or the perforation blade can advance also up to the more compact outer layer depending on the design of the decorating layer and distribution of each of the layers.

### REFERENCE NUMBER LIST

1 mold tool
2 base mold
3 first mold counter piece
4 perforation tool
5 cutting blade
6 perforation needle
7 first cavity
8 support
9 opening
10 decorating layer
11 second cavity
12 predetermined rupture line
13 second mold counter piece
14 foam core
15 decorating skin
16 intermediate layer
17 knob with integrated cutting tool

1. A method for the production of a molded part having a predetermined rupture line (12) for an airbag opening and including a support layer (8) and a decorating layer (10), wherein the method comprises at least two injection molding cycles in an at least two step mold tool (1), wherein
a) in the mold tool (1) in a first step, the support layer (8) is formed at first by means of a first mating mold component (3) and in a first cavity via a first injection molding cycle; and
b) in a second step, a decorating layer (10) is deposited onto the completed support layer (8) in the mold tool (1) by means of a second mating mold component (13), and a second cavity (11) in a second injection molding cycle.
characterized in that, during the first injection molding cycle in the support layer (8) openings (9) are formed, by means of which in the second injection molding cycle, a perforation element (5, 6) of a perforation tool integrated into the mold tool is introduced into the decorating layer.

2. The method according to claim 1,
characterized in that, in the second injection molding cycle, a foamed layer is deposited as a decorating layer (10).

3. The method according to claim 2,
characterized in that, the second injection molding cycle is cycling through an expansion lift in order to form the foamed layer (10).

4. The method according to claim 1,
characterized in that, material for the support layer (8) is a thermoplastic material, selected from the group of polypropylene (PP), polyethylene (PE), polybutyleneterephthalate (PBT), polyamid (PA), polystyrene (PS), polycarbonate (PC), polymethylmethacrylate (PMMA), acryInitril-butadiene-styrene (ABS) acryInitril-butadiene-styrene/polycarbonate copolymerisate (ABS-PC) or polyoxymethylene (POM) is utilized.

5. The method according to claim 4,
characterized in that, the support layer (8) is reinforced with fibers, selected from the group of glass fiber, carbon fibers or textile natural fibers.

6. The method according to claim 1,
characterized in that, as material for the decorating layer (10) a thermoplastic elastomer (TPE) on the basis of polyurethane (PU), polypropylene (PP), polyethylene or polyamid (PA) is utilized.

7. The method according to claim 2,
characterized in that, as material for the foamed decorating layer (10), a thermoplastic elastomeric material (TPE) loaded with a foaming agent on the basis of polyurethane (PU), polypropylene (PP), polyethylene or polyamid (PA) is utilized.

8. The method according to claim 1,
characterized in that the mold tool (1) provided with an integrated perforation tool (4) that includes a cutting blade is utilized.

9. The method according to claim 1,
characterized in that, the mold tool (1) provided with an integrated perforation tool (4) that includes perforation needles is utilized.

10. The method according to claim 1,
characterized in that, the openings (9) are directly formed in the support layer 8 during the first injection molding cycle by means of the perforation tool (4) integrated into the mold tool.

11. The method according to claim 1
characterized in that the openings (9) are formed in the support layer (8) during the first injection molding cycle by means of a perforation tool (4) integrated into the base mold (2) of the mold tool (1) and provided with knobs.

12. The method according to claim 1,
characterized in that the perforation element (5, 6) of the perforation tool (4) which is integrated into the base mold of the mold tool (1) is introduced after the second injection molding cycle into the thermoplastic elastomeric material of the decorating layer which is not yet solidified, wherein in the extended position of the perforation tool (4) a thin unweakened residual wall remains in the decorating layer (10).

13. The method according to claim 1,
characterized in that the perforation element (5, 6) of the perforation tool (4) which is integrated into the base mold of the mold tool (1) during or after the expansion lift of the mold counter piece (13) is introduced into the not yet solidified foam of the thermoplastic elastomeric material of the foamed decorating layer (10), wherein in the extended position of the perforation tool (4) a thin residual wall remains in the foamed layer (10).

14. A device for the production of a predetermined rupture line (12) for a molded part having an air bag opening, wherein the device comprises an at least two step mold tool (1) and a first mating mold component (3) having a first cavity (7) for forming a support layer 98) in a first step and a second mating mold component (13) having a second cavity (11) for the formation of a decorating layer (10) in a second step,
characterized in that, a perforation tool (4) which includes a movable perforation element (5, 6) is integrated into the base mold (3) of the mold tool (1).

15. The device according to claim 14,
characterized in that, the second cavity (11) is expandable for the formation of a foamed layer (10).

16. The device according to claim 14,
characterized in that, the perforation tool (4) which is integrated into the mold tool (1) is provided with a cutting blade for inserting into the decorating layer (10).

17. The device according to claim 14,
characterized in that, the perforation tool (4) which is integrated into the mold tool (1) is provided with perforation needles (6) for insertion into the decorating layer (10).

18. A molded part produced according to a method according to claim 1 as interior paneling for motor vehicles, in particular, dash boards, side paneling or door paneling.
